(19) United States
(12) Patent Application Publication
(10) Pub. No.: US 2008/0010164 A1
(43) Pub. Date: Jan. 10, 2008

(54) METHOD AND SYSTEM FOR THE NETWORK-BASED OFFERING OF GOODS, SERVICES AND/OR OTHER ITEMS OF VALUE

(75) Inventor: Frank Schueler, Karlsruhe (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/775,552

(22) Filed: Jul. 10, 2007

(30) Foreign Application Priority Data
Jul. 10, 2006 (DE) 10 2006 031 878.1

(51) Int. Cl. G06Q 30/00

(52) U.S. Cl. 705/26

(57) ABSTRACT

A system and method for offering goods, services, and/or other items of value to a user via a network includes displaying a selection of online shops to the user on a website visited by the user. The selection of the online shops depends on at least one predeterminable criterion assignable to the user. Upon a selecting of a first of the online shops by the user, the user is provided with access to the selected first online shop.

The present application claims priority to German Patent Application DE 10 2006 031 878.1, filed Jul. 10, 2006, the contents of which are hereby incorporated by reference as if set forth in their entirety.

The invention relates to a method and system for the network-based offering of goods, services and/or other items of value, such as access rights, entry rights, service privileges, bonuses, etc. In particular, the invention relates to a method and system for offering the abovementioned items of value (hereafter also called “Assets”) to Internet users via so-called online shops.

### BACKGROUND

Online shops have already been known for years within the field of electronic commerce (“e-commerce”). The English concept of the online shop has, in the meantime, been incorporated into the German language to describe the marketing of goods via a dealer's Internet presence. Further names for an online shop, in particular for its organizational manifestation, include “webshop” or “e-shop”.

Conventional online shops are, in each case, set up for themselves on a website or Internet presence or in a subdirectory of a website such as in a subdirectory of an online portal. Usually the user then always finds himself in this one online shop. Any access to other shops takes place via links, which are integrated e.g., as banner advertisements, in the shop currently visited.

A central starting point for several shops is offered by so-called shop portals. These, however, merely offer catalogue-type collections which are, as a rule, listed according to sectors.

### SUMMARY

More intelligent methods and systems which offer the user different purchasing possibilities in the form of various online shops would be desirable. Additionally, an integration in a useful service, in particular in a network-based communication service, should also be possible.

An embodiment of the present invention provides a system and method for offering goods, services, and/or other items of value to a user via a network. A selection of a plurality of online shops is displayed to the user on a website visited by the user. The selection of the online shops depends on at least one predeterminable criterion assignable to the user. Upon a selecting of a first of the online shops by the user, the user is provided with access to the selected first online shop.

### BRIEF DESCRIPTION OF THE DRAWINGS

Exemplary embodiments of the present invention are explained in more detail below with reference to the accompanying drawings, in which:

FIG. 1 illustrates a system architecture according to an embodiment of the present invention;

FIG. 2 illustrates a screen of the system architecture according to an embodiment of the present invention;

FIG. 3 illustrates a flowchart of a method according to an embodiment of the present invention;

FIG. 4 illustrates a flowchart of a method according to an embodiment of the present invention;

FIG. 5 illustrates a flowchart of a method according to an embodiment of the present invention;

FIG. 6 illustrates a flowchart of a method according to an embodiment of the present invention;

FIG. 7 illustrates a flowchart of a method according to an embodiment of the present invention;

FIG. 8 illustrates a screen according to a system of an embodiment of the present invention;

FIG. 9 illustrates a screen according to a system of an embodiment of the present invention;

FIG. 10 illustrates a screen according to a system of an embodiment of the present invention;

FIG. 11 illustrates a screen according to a system of an embodiment of the present invention;

FIG. 12 illustrates a diagram for a purchasing process according to an embodiment of the present invention;

FIG. 13 illustrate a diagram for a purchasing of tariffs according to an embodiment of the present invention; and

FIG. 14 illustrates a screen according to a system of an embodiment of the present invention.

### DETAILED DESCRIPTION

An aspect of an embodiment of the present invention is to perceptibly improve a method or system of the type mentioned at the outset and make it particularly user-friendly. This can be achieved by a system and method for the network-based offering of goods, services and/or other items of value.

In an embodiment of the present invention, on a website visited by a user, depending on at least one predeterminable criterion which can be assigned to the user, a selection of at least two online shops is displayed, and that upon selection of an online shop by the user, the user is provided with access to the selected online shop.

The user is thereby offered a selection, optimized for him personally, of online shops. The website serves as it were as an overview and start page for direct access to various shops. The website is herein also referred to as a ShopDispatcher (distributor for online shops). The shop selection is displayed intelligently depending on criteria which can, in particular, be related to the user and/or his online behaviour. The Internet presence or website with the optimized shop selection can, in particular, be integrated in a service also offered on this website, such as an Internet-based communication, wherein suitable software, etc. can then be bought for this from the desired shops. The software relates in particular to extension features for the use of the Internet-based communication. In at least some of the shops offered, specific tariffs for the use of the service can also be booked and optionally further rights acquired such as e.g. rights of access to exclusive Internet areas, in particular, to so-called closed-user areas/groups, granted advantages such as e.g. bonus or rebate for the supply of further goods and services, etc.

The “ShopDispatcher” solution proposed here results in very many possibilities for offering users a wide selection range, wherein the individual user is supplied with offers optimally tailored to him or her. These and further advantages also follow from the following description of embodiment examples.

In an embodiment of the present invention, it is advantageous if, when a user visits the website, at least one of the following criteria is examined for display of the selection, namely a user identity such as an email address, a terminal identifier such as the user's IP address, or a property of the user and/or his Internet access such as the nationality or language or country identifier. Alternatively or also additionally, it is advantageous if a service is offered to the user on the website for the use of which the online shops displayed for selection offer basic or additional software, rights of use and/or service features.

It is also of advantage if additionally the criteria which can be assigned to the user are stored in a user profile assigned to the user. Alternatively or additionally to this, the selection of online shops made manually by the user is preferably recorded and evaluated, in order to produce a list of preferred online shops. These shops are also here called “PreferredShops”. Further advantages result if in particular in this connection the selection is determined and displayed on the basis of a list of preferred online shops.

For the realization of the “ShopDispatcher” presented here, besides the novel method a system is also provided which comprises means, in particular at least one server, which provides a website, and which is designed to carry out the novel method.

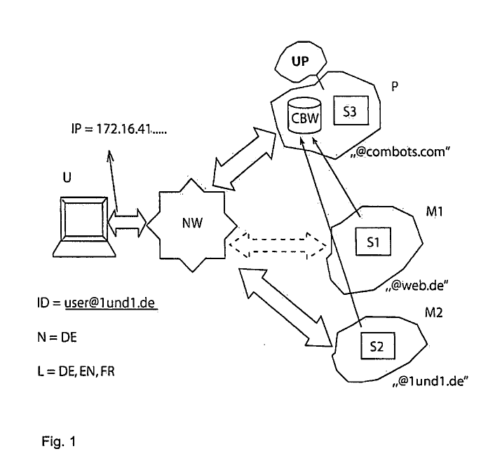

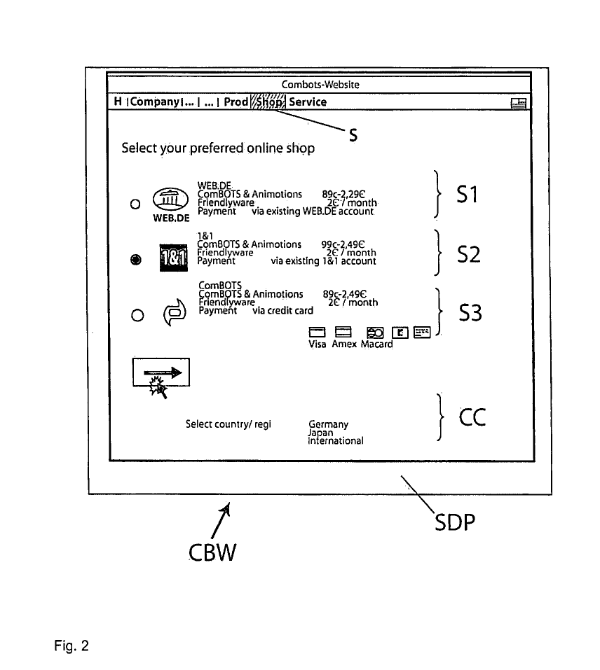

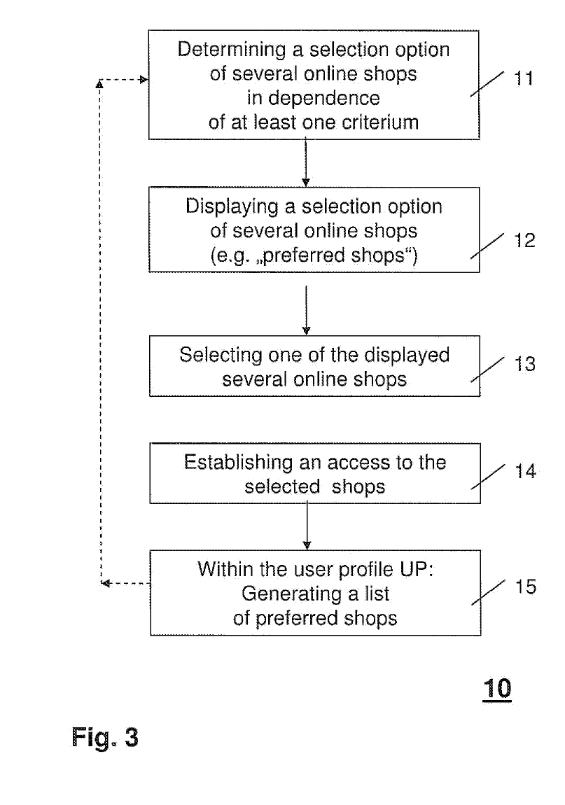

FIG. 1 shows a schematic representation of a network architecture, in which the method and system according to the invention are realized in the form of a first embodiment example. FIG. 2 shows a website associated with this with the selection possibility for various online shops. FIG. 3 reproduces the method according to this example in the form of a flowchart. Reference is therefore first made here in particular to these FIGS. 1 to 3.

The system according to an embodiment of the present invention is preferably realized for Internet-supported networks, such as the network NW represented in FIG. 1. The system comprises, in particular, one or more servers which provide a website CBW or Internet presence. Users, such as the user U, have access to this CBW website. He uses his terminal for this purpose and preferably accesses the CBW website with a browser via his Internet access, which here has the (temporary) address IP. The CBW website is provided by a service provider P, here e.g., provided by the applicant, which offers and operates an Internet-supported communication service called ComBOTs™ and according to the present invention also provides alternative access to various online shops. ComBOT™ and ComBOTs™ are trademarks of ComBOTS Product GmbH.

The communication service provides for an at least temporary networking of the user terminals with each other and/or with the servers of the service provider, with the result that both direct connections (peer-to-peer) and indirect connections(store&forward) can be created. The users can use as terminals, for example, desktop computers, notebooks, PDAs (Personal Digital Assistant), mobile telephones, and the like. For the users of the system, an Internet-based communication results, which integrates or brings together the many types of communication and multimedia services and possibilities, wherein all the possibilities for the provision and exchange of information can be included. The system combines or replaces individual services such as for example instant messaging services, Internet telephony services (Voice over IP or VoIP in short), data exchange services (FileSharing) or data access services (WindowSharing) or also data provision services, in particular for video, audio, image and program data.

The intelligent selection of different online shops is displayed on the CBW website, e.g., under the URL (Uniform Resource Locator) http://shop.combots.com/. When visiting this website the user U firstly obtains a screen display such as the one illustrated in FIG. 2. Different online shops S1, S2, S3 are offered for selection by the user U there. This selection can be determined manually or automatically, and depends on criteria which are preferably allocated to the user U with the result that the selection can be tailored to this user.

The method 10 illustrated in FIG. 3 begins with a step 11 to determine or to make a selection possibility from several online shops depending on such criteria. Criteria can be, say, a user and/or terminals address or access address, such as the IP address of the Internet access, the e-mail address of the user, a country identifier or nationality N and/or details L about the user's preferred language(s). In the example shown here, the user has German nationality (N=DE) and speaks or prefers the languages German, English and French (L=DE, EN, FR). The user has e.g. the email address user@1und1.de. And the Internet access has the IP address “172.16.41 . . . ”.

Now, at least one of the criteria is cited or evaluated in step 11 to optimize the display for the shop selection. This preferably occurs network-side, with an operator of the CBW website who has stored in each case a user profile UP for the users already known to him, in particular, for the service users already registered with him. Thus, when a user U visits, it can be checked whether a profile UP with such criteria already exists for this user. By comparing the stored profile data with the entries made by the user U which he made when visiting the CBW website, in particular, when logging in to or applying to the communication service, the identity of the user can thus easily be established and an optimum selection of online shops offered to him.

It is also possible, as a criterion, to check the IP address in order to be able to deduce the access location or the whereabouts of the respective user. Thus, the culture group or the preferred language can also easily be ascertained and an intelligent pre-selection of e.g., three preferred shops can be offered. The criteria can at least partly be stored also by means of so-called cookies on the user terminals and retrieved from the system when needed. The criteria need not apply to just a single user. Thus, e.g., whole groups of IP addresses, so-called IP circles, can also be used as criterion or email domains, etc. Thus, for example, the region, the company, or the Internet provider of several users can be recognized and the shop-selection display be evaluated in step 11 for pre-selection or pre-filtering.

Step 12 then follows with a display of a corresponding collection or list of shops (see FIG. 2) which, because of the pre-selection tailored to the user with, for example, the shops S1 to S3, is particularly appealing and attractive to the respective user. In turn, the method is also very advantageous for the participating shop operators because it channels the user streams with a clear goal in mind. If, for example, a user has an IP address from the address range of a Spanish Internet provider, then a CBW website in Spanish with preferably online shops of Spanish and/or regional suppliers and/or with regional products and/or services is preferably displayed to him. In the present example according to FIGS. 1 to 3, online shops are preferably displayed which offer software or performance features for the above-named ComBOTs™ communication service and/or cooperate with the service provider P.

As providers of the displayed shops in particular dealer outlets (so-called merchants) come into question, such as here e.g., the dealer WEB.DE, who as merchant M1 offers or operates the shop S1 and the dealer outlet 1&1 which as a further merchant M2 offers or operates the shop S2. Also the service provider P, i.e., ComBOTs™ themselves, operates a shop, namely shop S3. The user can freely choose between these shops S1, S2 or S3 via the representation or display SDP of the CBW website and, in particular, highlight his preferred shop. This shop is linked to the user identifier, e.g., to his email address, so that later an access to this shop can immediately be established. The service provider P or the shop selection or webpage SDP provided by him on his CBW website can therefore also be understood as a technically realized function of a business agent or distributor and also therefore be called “shop dispatcher”.

In particular, the service provider P can also operate, i.e., set up on the servers of the service provider P and operate technically, the respective online shop S1, S2, etc. and also for the individual merchants M1, M2, etc. To the outside and vis-a-vis the users, however, the merchant preferably appears. In order that the customer can buy in one of the offered shops, he enters into a so-called shop framework agreement with the respective merchant, wherein in particular the payment processes can be handled via the respective merchant. With the service provider P himself, the customer has a so-called basic agreement which governs the supply or the use of the actual service, namely the use of the communication service ComBOTs™. The respective user, here the user U,, is then registered or managed under an unambiguous identifier, preferably under a personal email address which the service provider P allocates to him, here under the email address user@combots.com.

Additionally the user can also enter with the provider P into a shop framework agreement for the use of the shop S3, wherein he is preferably also listed there in the shop S3 as a customer under the same identifier, i.e., user@combots.com. In the other online shops, email domains correspondingly supplied to the merchants such as e.g., @web.de or @1und1.de can be used so that the user is then listed there as a customer under user@web.de or user@1und1.de.

Access to one of the offered online shops S1, S2 or S3 is via the central selection website or webpage SDP (see FIG. 2), on which in particular the details concerning the terms of use such as prices and/or tariffs are displayed. As already described above, this display can be optimized depending on criteria (see steps 11 and 12 in FIG. 3). Then in a step 13 the user can make his personal choice and select at least one of the shops offered. In this example, the user U chooses shop S2 which is operated by the merchant M2, i.e., the shop of “1&1”. The user U confirms the choice made by clicking on the confirmation button. Additionally, the user can also add manual details about his personal preferences, such as e.g., country selection CC or language selection.

The system of the provider P creates access to the chosen shop S2 in step 14. This selection of the preferred shop can also be stored in the user profile UP of the system with the result that upon a later visit to the CBW website or when using the ComBOTs™ communication service the user U preferably finds this shop S2 displayed. Further, already recorded data, such as e.g., the user's manual entries concerning country selection CC, are also stored in the user profile UP in order to display an even better optimized selection of online shops during future visits. In particular, a list with preferred online shops is entered in step 15. Optionally, further criteria are also recorded there. Thus, the preferred shop or at least a selection, produced according to the given criteria, of online shops can be offered directly for future visits to the website CBW. This back coupling is shown in FIG. 3 by a loop-back from step 15 to step 11.

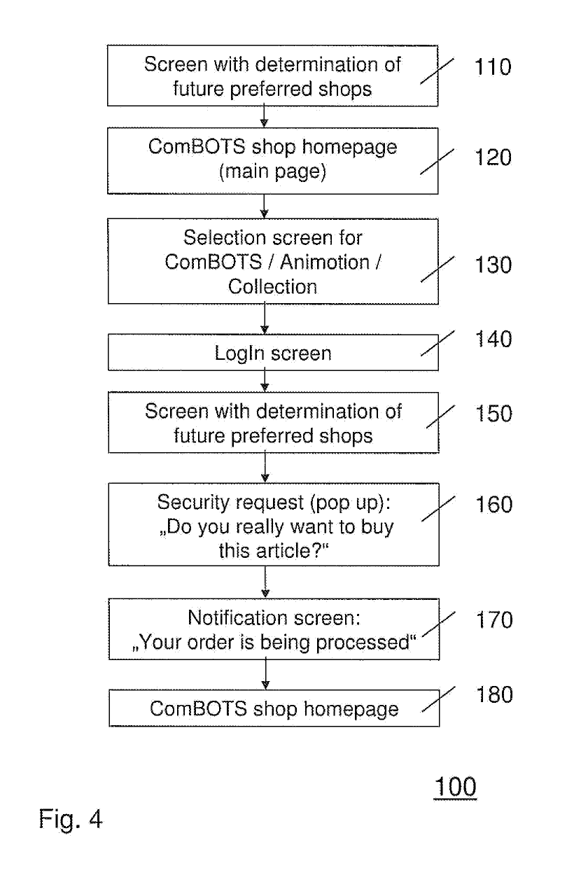

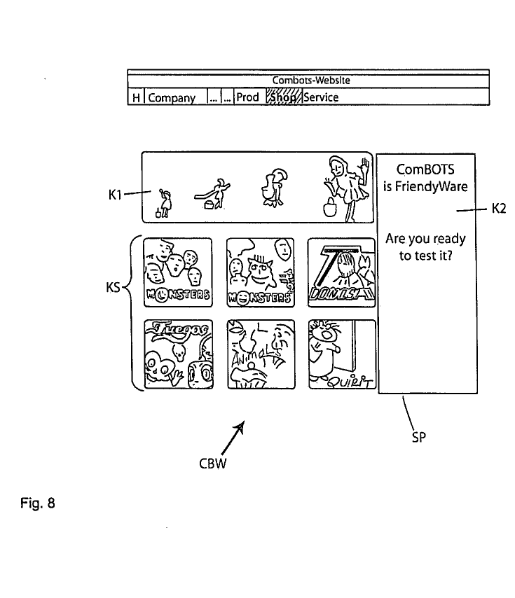

Further examples of methods according to the invention are represented in the form of flowcharts in FIGS. 4 to 7. Steps for carrying out purchase processes which are also further illustrated by the FIGS. 8 to 11 are also reproduced here. Reference is made to all these FIGS. 4 to 11 here.

The method 100 represented in FIG. 4 assumes that the user first becomes aware of the intelligent shop selection, preferably when using the ComBOTs™ communication service. A screen display with preferred shops for the user is set out in a first step 110. This is based on the already-named criteria, which are preferably stored in the user profile of the ComBOTs™ user, i.e., in the user profile which is actually used for the communication service.

Thus, the communication service also serves to guide the users to the online shops via a suggestion or selection function for preferred shops. As soon as the user has selected his preferred shops, he enters the main page of this shop in a step 120 in this example the main page of the ComBOTs™ shop (see S3 in FIGS. 1 and 2). FIG. 8, for example, shows such a main page SP. As the ComBOTs™ shop is displayed here, this shop is also found on the CBW website or on one of the servers of the provider ComBOTs™. The shop can also be visited on the Internet directly under the shop's URL, such as http://shop.combots.com, a possibility which is described below.

The shop main page SP comprises, in particular, different types of so-called tiles K1, K2 and KS. These are fields or banners on which the user can click with the mouse pointer or cursor, whereby then a function, in particular, a redirection to a next webpage, is triggered.

In the shop, goods and services are offered which are preferably connected with the communication service of the same name offered by the service provider or service offerer ComBOTs™ (see P in FIG. 1). In particular, software for implementing the communication or to broaden performance features, etc. are offered. It is to be kept in mind that the communication takes place via animatable avatars, also called ComBOTs™, which have extensive forms and functions.

These ComBOTs™ are achieved in software and are offered for purchase. The ComBOTs™ represent characters and are divided into specific groups or collections, such as animal figures, comic figures, mangas, monsters, etc. These can be selected by the user. The user can then buy individual ComBOTs™ from these or even the whole collection. A collection comprises not only the characters, i.e., the ComBOTs™, per se, but also so-called eMotions. This is additional software with which the ComBOTs™ can be animated in a particular manner in order in particular to represent emotions and transmit these to the communication partner. eMotions are high-quality animations which can make the ComBOT™ laugh or cry, etc. Thus, a non-verbal communication can be carried out very easily.

Several fields or tiles KS for the selection of collections are represented on the shop website SP, shown in FIG. 8. Thus, a list of preferred collections is presented, i.e., collections which should appeal particularly strongly to the user in question. The control system for representing preferred collections is comparable with the above-described control system for the display of preferred shops (see FIG. 2) i.e., also with the help of user-related or user-relevant criteria. These measures, or this procedure, is informed by the notion that user-optimized collections within the framework of online shopping are displayed according to the criteria which can be allocated to the user.

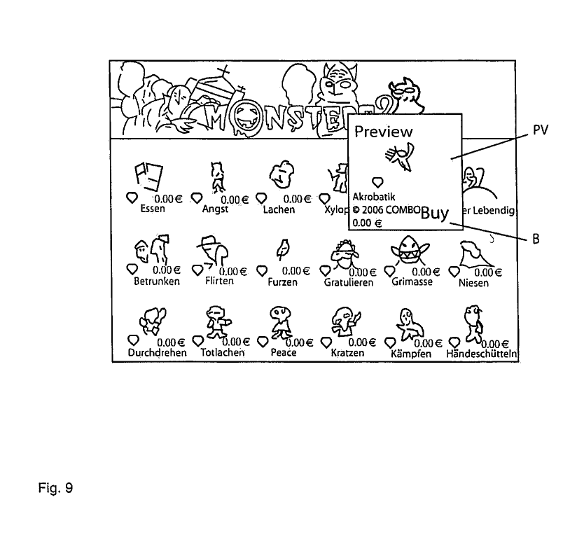

In the example shown here, tiles KS for six collections are displayed which have the following names: “Monsters”, “Monsters2”, “Dojinshi”, LosFuegos”, “Animals” and “Quirit”. By clicking on one such tile KS the user then reaches the selected collection, e.g., here “Monster2”, as is represented in FIG. 9.

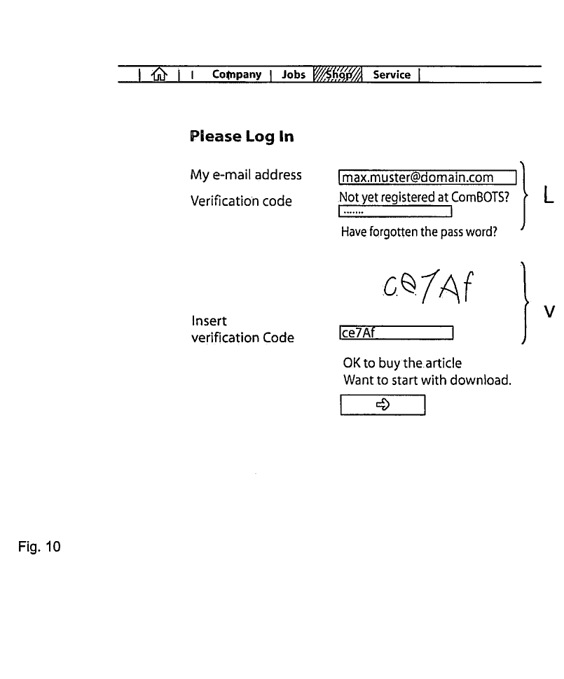

If the user is not yet registered, in step 140 he reaches a corresponding registration or login page as is represented in FIG. 10. There the user can register or login, by means of his user identifier, here e.g., with his email address, and his password. Additionally, a verification code V is also requested. Then in step 150, the user reaches the selection page (see FIG. 8). Alternatively, the user can also be guided directly to the chosen collection, as can be seen in FIG. 9.

The collection (see FIG. 9) comprises ComBOTs™ and eMotions which are offered for purchase to the user in the form of individual tiles or banners. By touching such a tile the corresponding ComBOT™ is enlarged or the eMotion played, preferably with sound. A preview function PV is also executed which the user triggers by mouseover. The individual purchase item (ComBOT™ or eMotion) is represented on each tile as well as a price and a button (“buy”) with which the user can arrange to buy the item by clicking on it.

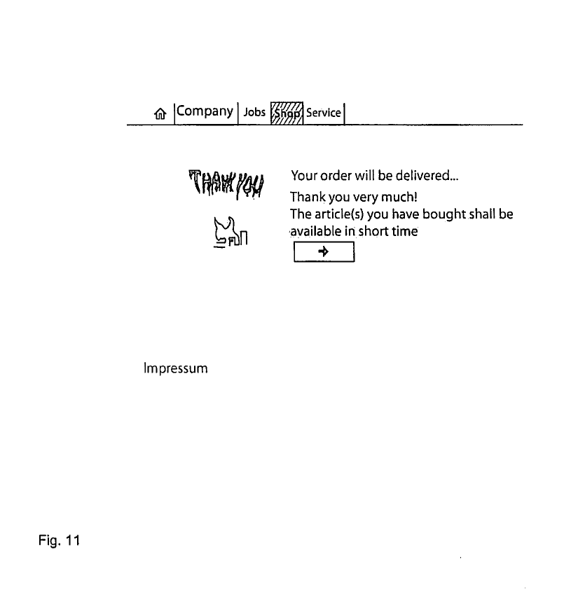

Step 160 then optionally follows, asking the user, as a security question, whether he or she really wishes to purchase the item (see FIG. 4). If the user's answer is yes, then the purchase of the item or ordering of the item is confirmed in step 170 by a corresponding message on his screen (see also FIG. 11), which e.g., reads: “Your order has been dispatched . . . ”

The item is delivered in the form of software, electronically over the network, preferably over the communications network itself (see NW in FIG. 1). It can also be supplied by email or provided as a download. To complete the procedure 100, the user returns in a next step 180 to the shop's main page (see FIGS. 4 and 8).

The shop main page SP according to FIG. 8 contains, in addition to the tile KS for the preferred six collections, a main tile K1 which by clicking the mouse leads to a global view of all the collections offered in the shop. The shop main page SP also has another tile K2 which, by clicking the mouse, leads to a webpage which relates to the actual use of the ComBOTs™ communication service. Via the tile K2 the user can, by clicking the mouse, learn something about the so-called “FriendlyWare” and be registered as a full member with ComBOTs™.

The term “FriendlyWare” refers to a piece of software for testing ComBOTs™, wherein all functions are made available to the user free of charge and for an unlimited period of time. The user is merely asked in a friendly way to kindly register if so minded for full ComBOTs™ membership, whereupon a charge becomes payable. This marketing strategy is also called “FriendlyWare” here. The user can also decide for himself quite naturally when he wishes to become a full member.

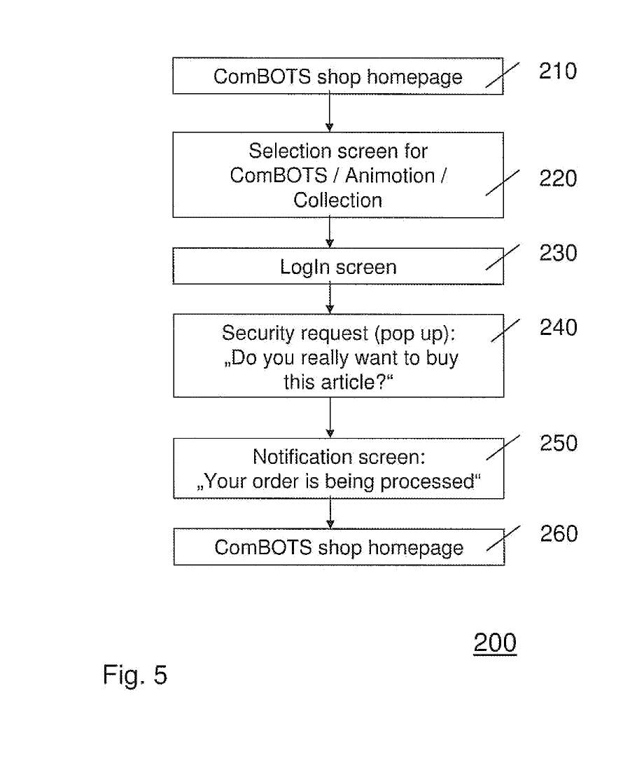

As an alternative to the method according to FIG. 4, FIG. 5 shows another method 200 in which it is assumed that the user has already previously visited at least one of the shops and is thus known as a customer to the respective shop operator and to the service provider P. It is assumed here that the user from the ComBOTs™ application, i.e., from the use of the communication service, wishes to visit a shop.

The user is then firstly shown the main page of the shop displayed to him in step 210. This is preferably the preferred shop highlighted in the user profile or e.g., recognized via the IP identifier. The main page of this shop can, for example, correspond to the webpage SP represented in FIG. 8 with selection tiles KS. It can also, however, first be simply a welcome page with the result that the selection tiles with the preferred items, i.e., with collections etc., (see tiles KS in FIG. 2) are not displayed until a next step 210.

Only when the user decides to purchase an item and indicates this by clicking the mouse on the corresponding tile is the user requested to register in a further step 230. This means that the user can first view all offers there in the shop, in particular via the preview function, without registration or logging in, or applying. Only when the user first initiates a purchase by clicking on the mouse is he asked to register in the shop (see step 230). This then happens via a so-called login screen, as is represented in FIG. 10. Together with the registration the payment procedures data for the purchase can be established. This happens, say, by polling the user database, in particular, the user profile. If no data are as yet stored for the payment transaction, the user can also specifically be requested to enter the payment data.

Before the purchase is processed, another security request is made in a step 240 in order to clarify that the user actually wishes to purchase the item. Then, in a step 250, the successful entry of the order is reported and the user is then returned to the shop in a step 260, e.g., to the main page there. The user is, however, preferably returned to that precise area of the online shop in which he or she was last and in particular made a purchase. If the user e.g., most recently bought a ComBOT™ from the “Monster2” collection, the user is returned directly to this collection when the purchase is concluded (see FIG. 9). The user is thus returned to the part of the shop most recently preferred by him. This increases transparency and the user's desire to buy.

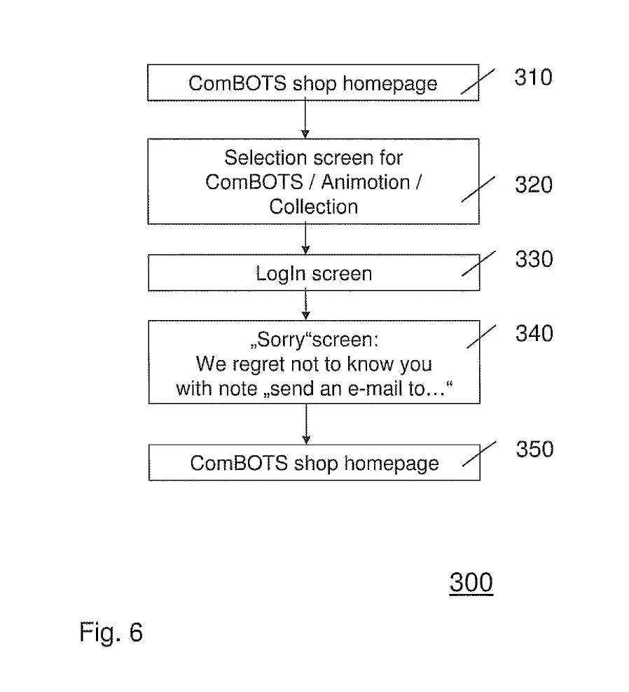

The method 300 illustrated in FIG. 6 starts from any Internet user not yet known the operator. The unknown user has reached the webpage of the shop, so to speak, as a potential purchaser and new customer. The potential purchaser is first shown the shop main page in a step 310. Then in step 320, the selection screen appears with the offered items, in particular with preferred collections (see FIG. 8). It is to be kept in mind that the selection may already be optimized even if the user has not yet registered and is thus not known to the system, i.e., there is not yet a user profile. A first selection can already be displayed optimized or filtered with the help of generally accessible criteria, such as e.g., the IP address of the Internet connection.

The user then registers in a further step 330. In particular, this involves recording the user as a shop customer, wherein using the details from login data it is checked whether this user is already registered. Any missing data would then merely be retrieved for processing of the payment. If the user cannot be recognized, as represented here in FIG. 6, then in step 340 a corresponding screen display appears “ . . . unfortunately we do not know you . . . ” and the user is asked to send a message, in particular an email, to an address named by the operator, such as new@combots-login.com.

The user will then obtain, optionally by email from the system, access data for his later registration. Then the user is returned to the shop main page in a step 350 and can now register there as a customer.

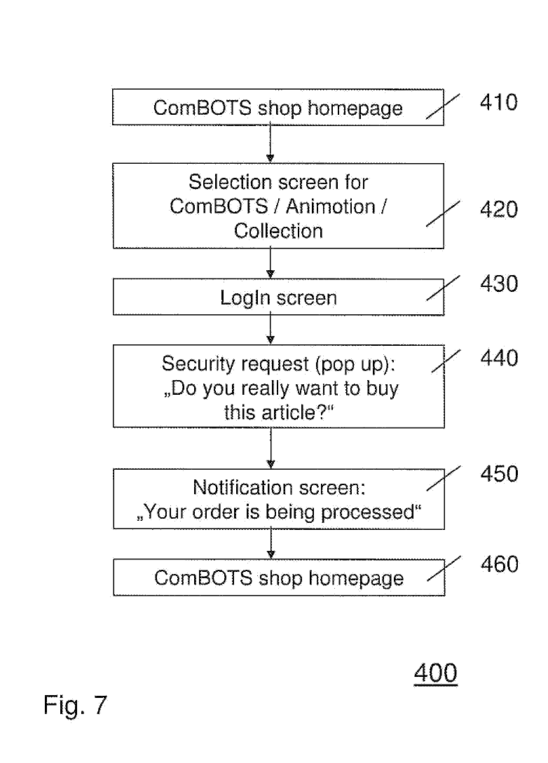

The method 400 illustrated in FIG. 7 assumes that the user is already registered as a user of the ComBOTs™ communication service, but that he is not yet a registered customer of the shop or has not yet logged in there. Here, the ComBOTs™ user goes e.g., to the shop website of the merchant or of the service provider in order to visit the shop.

Firstly, in step 410, the user reaches the shop main page or the start page of the shop. There, in step 420, he is offered a selection of items, in particular collections (see FIG. 8). If the user wishes to buy an item then he is asked to login via the login screen in a next step 430. Then at least the user identity is known to the operator. The data entered by the user for the desired payment transaction are preferably also known, such as one of various credit cards, direct debit and/or payment systems such as PayPal.

As a security measure, the user is also asked in a step 440 before the purchase is processed whether he really wants to purchase this item. If the answer is yes, then in step 450 the confirmation display for the successful order appears and preferably also for the electronic delivery of the product or of the item (see FIG. 11). Then, in step 460, the user is returned to his most recent starting point, i.e., to the shop main page, wherein the last-selected collection is preferably displayed to him.

The methods described above in particular with the help of FIGS. 3 to 7 have in common that the user can, in the at least one online shop, view all items offered there and, using the preview function, look at them in more detail without the user having to be already registered in the shop. A distinction is drawn between cases where the user is either already a user of the communication service and thus is at least known to the ComBOTs™ service provider or is a still unknown user, i.e., a potential purchaser.

The shop can be accessed either via the system or the ComBOTs™ service or via a visit to the website or to the shop main page. The methods advantageously connect or link the service application, here ComBOTs™, to at least one online shop, wherein the user is shown optimized displays of items for selection. The optimization is based on criteria which can be allocated to the user. With known users, data can be retrieved from an already existing user profile. With still unknown users, also generally recordable criteria, such as e.g., IP address, time or (manual) language choice etc. can also be used.

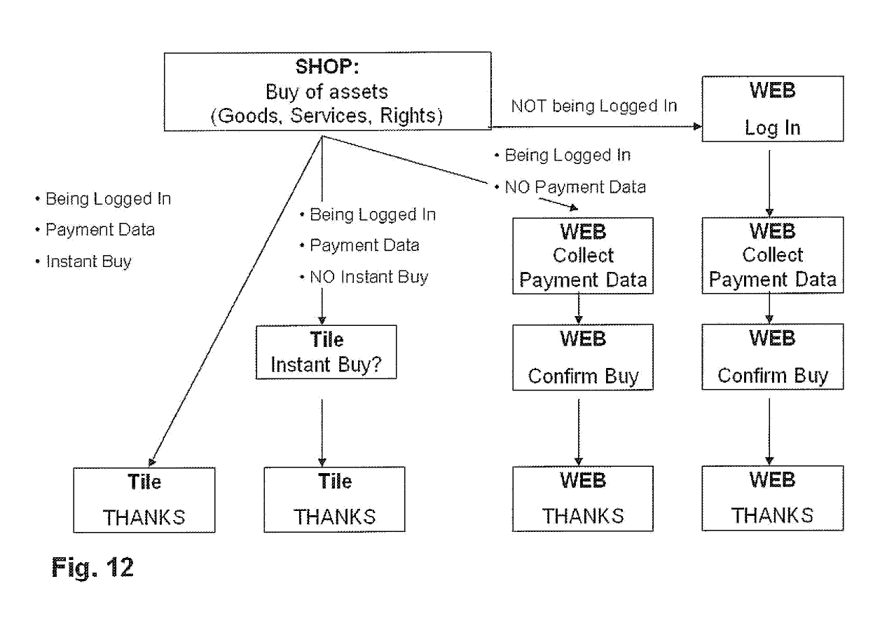

FIGS. 12 to 14 illustrate other possibilities of making the user different offers and offering these for sale via the system within the shops. FIG. 12 relates to a purchase process for goods, services, rights and other items of value which we generally call “assets” here. By goods are meant here, in particular software for the multifunctional avatars called ComBOTs™ and for applications, tools, files, in particular video and/or audio files (e.g., MP3) and/or software for functions or animations, such as the above-described eMotions. Services are, in particular, communication services, such as the above-described ComBOTs™ service, and the provision of online accesses to or use of webspace, memory capacity, etc.

By rights are meant, in particular, access rights for closed areas (closed user areas, VIP areas), for the supply of exclusive messages (e.g., via RSS technology=Really Simple Syndication) etc. FIG. 12 also illustrates the instant purchase function in which the user can expedite the purchase process. The asset is immediately delivered if the user displays this. In this embodiment, there is no security request, e.g., via a pop-up window (cf. steps 160, 240 or 440 in FIGS. 4, 5 and 7 respectively). Thus, the item can be delivered immediately. The user simply needs to activate the “instant purchase” option.

According to FIG. 12, a distinction is drawn between the following cases upon purchasing such assets:

If the user is already logged in to the system or shop, and the payment data are known, and additionally the “instant purchase” option is also activated, then when the item is selected the purchase is immediate, and the “thank you” tile or display appears (see FIG. 11). This is preferably displayed on a tile, i.e., integrated in the representation of the tile with the preview function PV (see FIG. 9).

If the user is already logged in to the system or shop, and if the payment data are known, but the “instant purchase” option is not activated, then upon selection or upon purchase, the tile or question whether the user would like to activate “instant purchase?” appears first. Only thereafter does the “thank you” tile or display appear (see FIG. 11). Here, too, this is preferably displayed on a tile, i.e., integrated in the representation of the tile with the preview function PV (see FIG. 9).

If the user is logged in to the system or shop but no payment data are yet known, then the payment data are requested or recorded first. This happens e.g., via a browser window. Only thereafter is the purchase process continued, finishing with a purchase confirmation followed by a display of the thank you window (see FIG. 11).

If the user is not logged in to the system or shop, then the user is requested to log in or sign in first. Then the payment data are requested or recorded. This also happens e.g., via a browser window. Only thereafter is the purchase process continued, finishing with a purchase confirmation followed by a display of the thank you window (see FIG. 11).

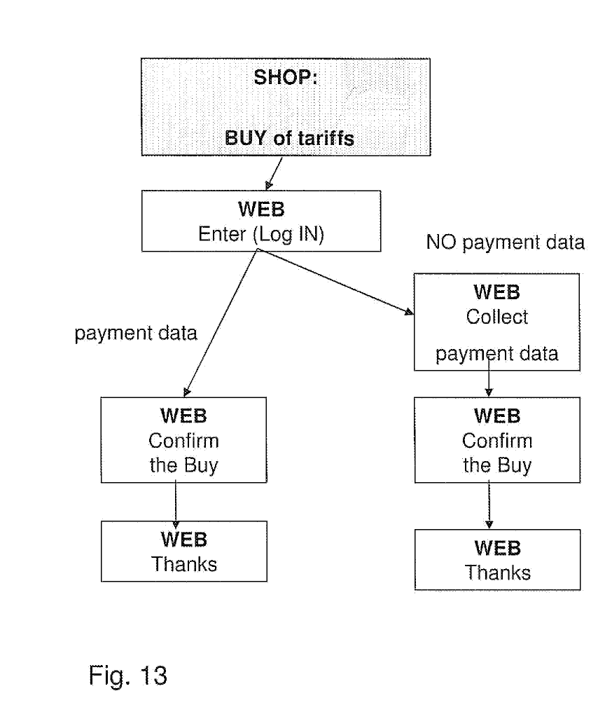

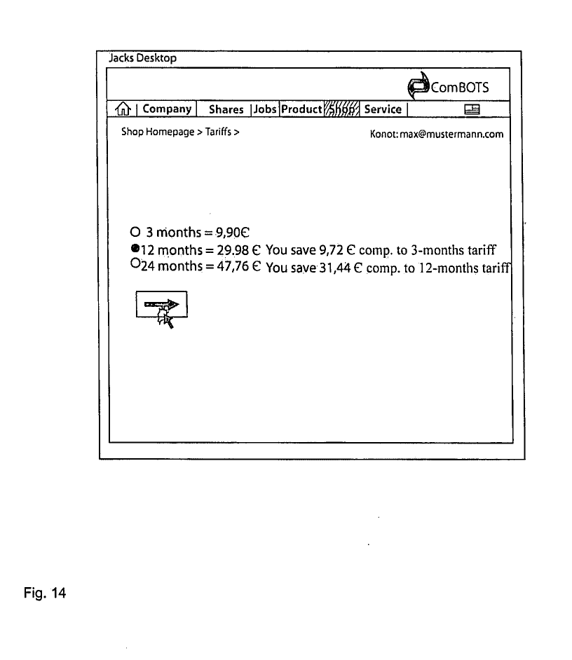

In FIGS. 13 and 14, cases are illustrated in which the user is offered prices, in particular tariffs for the use of the ComBOTs™ service in the form of a full membership (full subscription), which has already been described above under the so-called FriendlyWare model.

Firstly the user is asked to sign in or log in to the system and/or shop. Then it is checked whether there are already payment data for this user. If this is the case, the purchase process can be continued, the user is offered several tariffs, namely the following three variants (see FIG. 14): a three-month tariff for e.g., 9.90 euros, a twelve-month tariff or yearly tariff or a two-year tariff, wherein these longer tariffs are much more advantageous than the short-term tariff.

If the user has chosen a tariff, the purchase is confirmed and then the thank you window is displayed (see FIG. 11). However, if there are no payment data, these are requested or recorded first. This happens e.g., also via a browser window. Only thereafter is the purchase process continued, finishing with a purchase confirmation followed by a display of the thank you window (see FIG. 11).

While the invention has been particularly shown and described with reference to preferred embodiments thereof, it will be understood by those skilled in the art that various changes in form and details may be made therein without departing from the spirit and scope of the invention.

What is claimed is:

1. A method for offering goods, services, and/or other items of value to a user via a network, the method comprising the steps of:
displaying, on a website visited by a user, a selection of a plurality of online shops to the user, the selection of the online shops depending on at least one predeterminable criterion assignable to the user; and
upon a selecting of a first of the online shops by the user, providing the user with access to the selected first online shop.

2. The method as recited in claim 1, wherein the at least one predeterminable criterion includes at least one of a user identity, a terminal identifier, and a characteristic of at least one of the user and the user's network access, and further comprising checking at least one of the at least one predeterminable criterion so as to determine the selection of the online shops.

3. The method as recited in claim 2, wherein the user identity comprises an email address, the terminal identifier comprises an IP address, and the characteristic comprises at least one of a nationality, a language, and a country identifier.

4. The method as recited in claim 1, further comprising offering a service on the website to the user, and wherein at least one of the online shops offer, for a use of the service, at least one of basic or additional software, a right of use, and a service feature.

5. The method recited in claim 1, further comprising storing the at least one predeterminable criterion in a user profile assigned to the user.

6. The method recited in claim 1, further comprising recording and evaluating the selecting by the user so as to produce a list of preferred shops of the online shops.

7. The method recited in claim 5, further comprising recording and evaluating the selecting by the user so as to produce a list of preferred shops of the online shops.

8. The method as recited in claim 1, wherein the displaying includes determining the selection using a list of the user's preferred online shops.

9. The method as recited in claim 1, wherein:
the website is operated by a service provider, and
at least one of the online shops is operated by a merchant of the at least one online shop or by the service provider.

10. The method as recited in claim 1, wherein the website is operated by a service provider, and further comprising:
storing a user profile allocated to the user; and
storing the at least one predeterminable criterion in the user profile.

11. The method as recited in claim 4, wherein the service is a communication service, and further comprising:
storing a user profile for the communication service; and
storing at least one of the at least one predeterminable criterion in the user profile;
and wherein the displaying is performed based on the stored at least one of the at least one predeterminable criterion.

12. A system for offering goods, services, and/or other items of value to a user via a network, the system comprising:
a plurality of online shops; and
a server unit operable to display at least two of the plurality of online shops on a website based on at least one predeterminable criteria assignable to the user, and operable to provide the user with access to a first online shop of the online shops based on the user's selecting of the first online shop.

13. The system as recited in claim 12, wherein the at least one predeterminable criterion includes at least one of a user identity, a terminal identifier, and a characteristic of at least one of the user and the user's network access, and wherein the server unit is operable to check the at least one predeterminable criterion so as to determine the selection of the online shops.

14. The system as recited in claim 13, wherein the user identity comprises an email address, the terminal identifier comprises an IP address, and the characteristic comprises at least one of a nationality, a language, and a country identifier.

15. The system as recited in claim 12, wherein the server unit is operable to offer a service to the user, and wherein at least one of the online shops offers, for a use of the service, at least one of basic or additional software, a right of use, and a service feature.

16. The system as recited in claim 12, further comprising a storage unit operable to store the at least one predeterminable criterion in a user profile assigned to the user.

17. The system as recited in claim 12, wherein the server unit is operable to record and evaluate the selecting performed by the user so as to produce a list of preferred online shops of the online shops.

18. The system as recited in claim 12, further comprising:
a service provider which operates the website; and
a plurality of merchants, each which operate a respective online shop of the online shops.

19. The system as recited in claim 12, further comprising a service provider which operates the website, and wherein the service provider operates at least one of the online shops on behalf of a merchant.

20. The system as recited in claim 12, further comprising:
a service unit operable to offer a communication service; and
a storage unit operable to store a user profile for the communication service and to store at least one of the predeterminable criterion in the user profile;
and wherein the server unit is operable to display the selection of the online shops based on the stored at least one of the at least one criterion.
